(19) United States
(12) Patent Application Publication
(10) Pub. No.: US 2014/0129254 A1
(43) Pub. Date: May 8, 2014

(54) METHOD AND SYSTEM FOR HEALTH CARE PROVIDER CONTROLLED AUTOMATED MEDICAL HISTORY

(71) Applicant: Howard Schneider, Thornhill (CA)

(72) Inventor: Howard Schneider, Thornhill (CA)

(73) Assignee: DocPod Corp, Toronto (CA)

(21) Appl. No.: 14/153,043

(22) Filed: Jan. 12, 2014

(51) Int. Cl. G06F 19/00

(52) U.S. Cl. CPC G06F 19/363
USPC 705/2

(57) ABSTRACT

The system and method according to certain embodiments of the present invention substantially overcome the deficiencies of known systems and methods by including the health care provider's participation in the computer generation of the medical history. A preferred embodiment comprises utilizing the computer system requesting and/or allowing the health care provider's participation with the computer system at certain points in the otherwise automated medical history by the computer system. A single health care provider can simultaneously allow a plurality of patients to use the system to automatically generate medical histories for these patients. Alternative embodiments of the present invention can be used in fields outside of health care to allow a single computer operator to participate in the computer generation of histories for a plurality of users.

### FIELD

This invention relates to medical histories, and more specifically, relates to generating an automated medical history in which the health care provider participates in the process.

### BACKGROUND

In all areas of medicine, a medical history is the first step in arriving at a diagnosis and subsequently providing treatment to the patient. Traditionally, healthcare providers ask patients questions and in documenting the encounter generate a medical history.

There are many problems with generating a medical history that is accurate, comprehensive and economical. Ramsey and colleagues in a study entitled “History-taking and preventive medicine skills among primary care physicians: an assessment using standardized patients” published in the American Journal of Medicine in 1998, showed that of 134 primary care physicians studied, the physicians only asked 59% of what would be considered essential questions in order to obtain an accurate history from the patient. Tang and colleagues in a study published in 1995 entitled “Clinician information activities in diverse ambulatory practices” showed that physicians in ambulatory practices spent one-fifth of their day writing. Thus there is a high cost in relatively expensive physician time being spent on charting.

As early as the 1960's physicians were trying to use computers to solve the problems of generating a medical history that is accurate, comprehensive and economical. For example, in 1968 Mayne and colleagues at the Mayo Clinic in the USA published an article “Toward automating the medical history.” A mainframe computer attached to a terminal asked patients questions, with the patients using a light pen to point at possible answers on the computer terminal. U.S. Pat. No. 3,566,370 was awarded in 1971 to Worthington and Schwartzkopf for a computer system which could take a medical history from a patient.

In U.S. Pat. No. 4,130,881, awarded to Haessler and colleagues in 1978, they note that an improvement over U.S. Pat. No. 3,566,370 would be “useful to provide multiple pathways through the repertory to utilize only portions thereof in particular instances without necessity for answering a group of questions unimportant to a present investigation.” More than a decade later while the computer hardware for obtaining a history from a patient had greatly improved, automated medical history systems still followed a very mechanical list of questions, albeit with some branching, as suggested by U.S. Pat. No. 5,025,374 awarded in 1991 to Roizen and colleagues.

In the 1990s expert systems started to merge with automated medical history systems to allow more pertinent questions to be asked of patients. For example, in U.S. Pat. No. 5,517,405 awarded to McAndrew and colleagues in 1996, the computer “dynamically generates questions in response to previous answers provided by the user.” Five years later, automated medical history systems could handle even more complex program branching, but otherwise had not really changed that much. For example, in U.S. Pat. No. 6,334,192 awarded to Karpf in 2001, complex inverted tree type decision algorithms are discussed in an interactive risk assessment system. Also, at this time, automated medical history systems, as well as related patient monitoring systems, began to take more advantage of the availability of distant data communication technologies such as the Internet and widespread availability of portable and personal computer-based technology. U.S. Pat. 5,935,060 awarded to Iliff in 1999 makes use of the Internet and the use of “scripts.” U.S. Pat. Nos. 6,368,273 and 8,617,065 awarded to Brown in 2002 and 2013 respectively, describe the use of interactive “scripts” which are executable by a patient's remote apparatus. The scripts are generated by a “script generator” in a server. U.S. Pat. No. 6,383,135 awarded to Chikovani and colleagues in 2002 describe using a graphical interface to acquire medical information for triage purposes.

A decade later, automated medical history systems largely use the principles of the prior art described above, although improvements have continued. For example, in U.S. Pat. No. 8,571,890 awarded to Kalamas in 2013, the basis for automatically generating a medical history is based on the patient's medications. In U.S. Pat. No. 8,615,529 awarded to Reiner in 2013, the computer software takes into account the computer, intelligence and motor skills of the computer user, and thus allows the computer program to adapt dynamically to the user.

Nonetheless, despite the advancements and improvements discussed above, at the time of this writing, very few physicians or other health care providers make use of automated medical history systems, despite the potential advantages these systems offer. An article by Bachman entitled “The Patient-Computer Interview: A Neglected Tool That Can Aid the Clinician” was published in 2003 in the Mayo Clinic Proceedings. In considering why physicians may not want to use computer-based interviewing, Bachman notes, “A computer program does not necessarily distinguish background symptoms from those leading to a visit to a physician. The physician, the patient, or the software needs to determine what is relevant.” Unfortunately, the patient is usually not in a position to make this determination. Ideally, intelligent enough software should make this determination, but even with the advances in the referenced prior art, at the time of this writing, software does not exist that is capable to replicating the health care provider's clinical acumen. Thus, in order for an automated medical history system to be accepted by physicians and other patient care providers, the physician or other health care provider must be part of such system. If such a system is to be useful to the physician or other health care provider, their participation should represent significantly less time than they would spend on the history taking without an automated system.

### SUMMARY

The system and method according to certain embodiments of the present invention substantially overcome the deficiencies of known systems and methods by including the health care provider's participation in a very efficient and cost-effective fashion in the computer generation of the medical history. A preferred embodiment comprises utilizing the computer system requesting and/or allowing the health care provider's participation with the computer system at certain points in the otherwise automated medical history by the computer system.

These and other embodiments, features, aspects, and advantages of the invention will become better understood with reference to the following description, appended claims and accompanying drawings.

### BRIEF DESCRIPTION OF THE DRAWINGS

FIG. 1 is a block diagram of a computer system that can be used to implement the present invention.

FIG. 2 is a flow diagram of an automated generation of a medical history that includes the health care provider's participation.

FIG. 3 is a diagrammatic illustration of a patient input/output device's display screen.

FIG. 4 is a diagrammatic illustration of a health care provider input/output device's display screen.

FIG. 5 is a diagrammatic illustration of patient input/output device's display screen.

### DETAILED DESCRIPTION

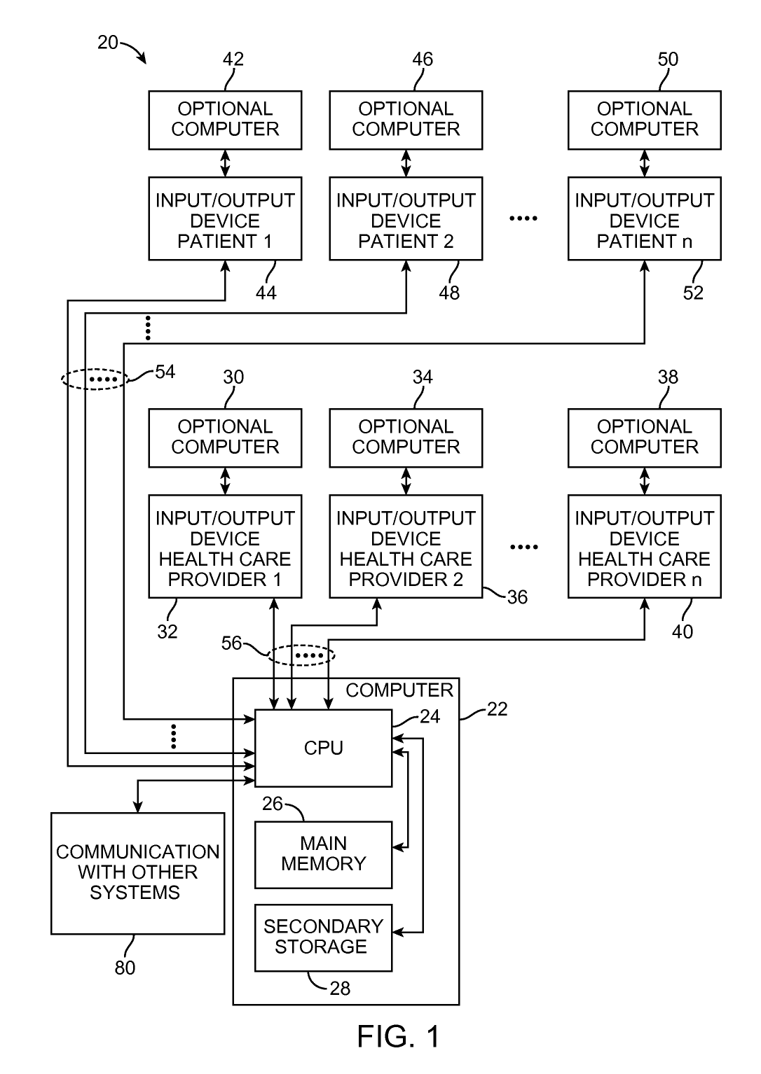

FIG. 1 illustrates an operating environment for an embodiment of the present invention as a computer system 20 with at least one computer 22 that comprises a central processing unit (CPU) 24 that works with a main memory 26 and a secondary storage memory 28. The computer 22 is connected to one or more patient input/output devices 44, 48, 52, and to one or more health care provider input/output devices 32, 36, 40 by one or more communication buses 54, 56 which can be wired, wireless, electronic, photonic, local, distant, or of any other familiar design, and incorporate wires, electrical cables, modems, antennas, routers, telephony, broadcasting, as well as any electronic or photonic device that allows data communication.

The computer 22 can be integrated with one of the health care provider input/output devices or with one of the patient input/output devices or standalone as shown in FIG. 1. The health care provider input/output devices and the patient input/output devices can be dedicated input/output devices, or as shown in FIG. 1 contain optional computers 42, 46, 50, 30, 34, 38 and contain some or all of the functionality of computer 22.

The computer 22 is of familiar design. The secondary storage 28 holds both the operating program as well as the data collected by the operation of system 20. As noted above, if other optional computers 42, 46, 50, 30, 34, 38 are used in system 20, then since these optional computers can contain some or all of the functionality of computer 22, portions of the operating program and collected data can reside in optional computers 42, 46, 50, 30, 34. The secondary storage 28 may be implemented as one or many magnetic disk drives, as solid-state secondary storage, as other familiar secondary storage systems, as a local storage and/or residing a distant location and/or residing in a distributed distant location, or other devices that store data using electrical, magnetic, optical or other recording media. The main memory 26 can be implemented as semiconductor random access memory (RAM), read only memory (ROM), video display memory, content addressable memory (CAM), as well as any other memory systems, alone or in combination, that use electrical, magnetic, optical or other techniques to store data and/or programs, for example, a solid state implementation of a neural network to encode data obtained by system 20.

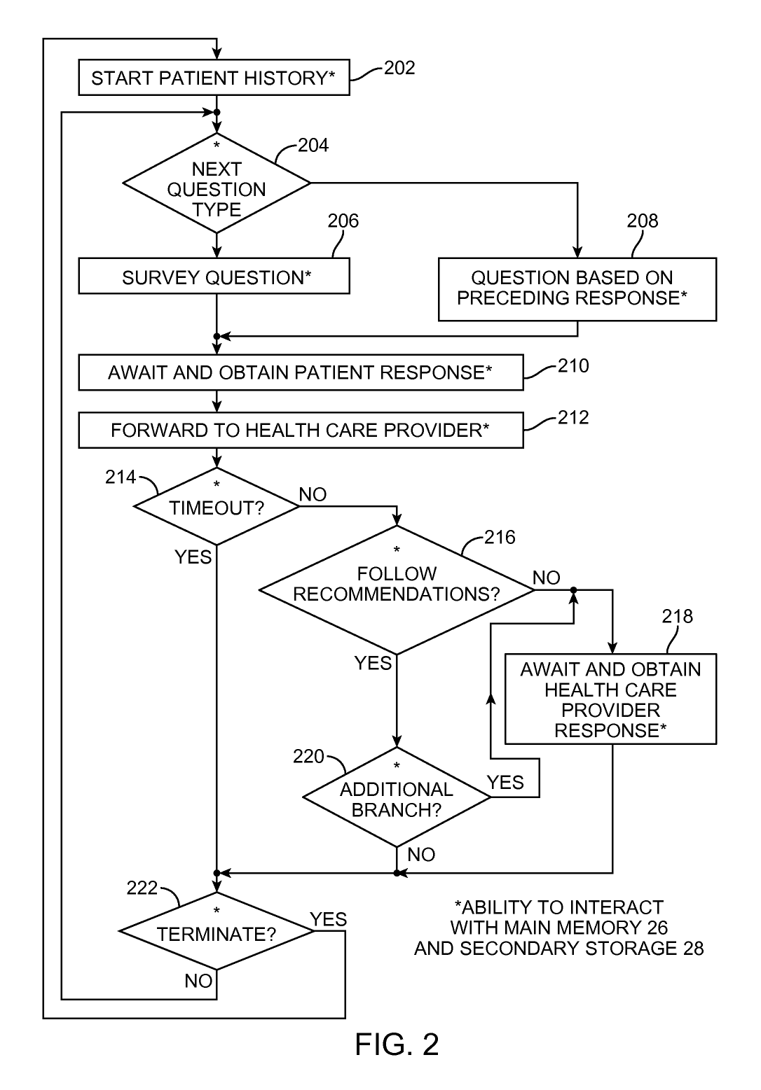

The computer 22, or equivalent distributed representation as discussed above, includes software in the secondary storage 28 and/or main memory 26 which allows the computer 22 to function at a basic level and is typically known as an operating system, as well as a higher level program which allows the computer 22 to particularly generate an automated medical history with the participation of one or more health care providers. FIG. 2 is a flow diagram of one such embodiment of such a higher level program, and is discussed below.

The patient input/output devices 44, 48, 52 and the health care provider input/output devices 32, 36, 40 can be any familiar input/output devices and can include in various combinations a keyboard, mouse, physical input transducers (e.g., microphone, video camera, fingerprint detector, weight scale, blood pressure transducer, etcetera), display screen, touchscreen, handheld or fixed touchscreen tablet, CRT display, LED display, LCD display, any other solid state display, printer, speaker, physical output transducers, or any other input/output electronic, electromechanical, photonic, mechanical, hydraulic device.

In accordance with the practices of persons skilled in the art of computer programming, a preferred embodiment of the present invention is described with reference to operations that are performed by computer system 20, unless indicated otherwise. There is a physical representation to these operations as ultimately data bits are maintained in physical locations, albeit which may be distributed at times, that have various electrical, magnetic, electromechanical, optical, electromagnetic, nuclear or weak force properties which correspond to these data bits.

FIG. 2 is a flow diagram of an automatic medical history generation with participation of the health care provider, or health care providers as the case may be.

Process block 202 indicates that the medical history generation is started. Messages from computer 22 and/or optional computer 42, for example, are sent to patient 1 input/output device 44. These messages may appear on a touchscreen and/or be spoken by a speaker, or arise in various other ways as described above, which are part of patient 1 input/output device 44. In a preferred embodiment of the present invention the patient is greeted. The patient is then asked why he/she is here or how he/she can be helped, as the opening question. The patient 1 input/output device 44 then awaits a response from the patient. As discussed above, as part of patient 1 input/output device 44 such an input can come from the patient by touching the touchscreen, using a keyboard, speaking to a microphone, or in any number of other methods discussed above.

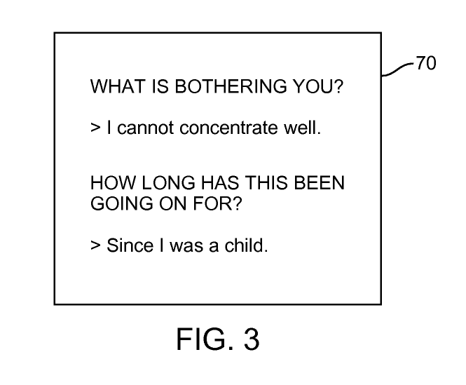

In FIG. 3 a touchscreen 70 which forms part of patient 1 input/output device 44 is shown. The system 20 first asks patient 1 “WHAT IS BOTHERING YOU?” In the example shown in FIG. 3, the patient has typed on the touchscreen the following response, “I cannot concentrate well.”

Returning to FIG. 2, decision block 204 indicates that system 20 must make a decision about the next type of question to ask patient 1, continuing the example started above. System 20 can ask the patient a question based on the preceding response, as indicated in process block 208, or can ask the patient survey questions to get more generalized information about the patient's problem or if the survey is so designed to focus further in on a diagnosis that accounts for the patient's problem. If only a single line of patient input has been entered so far, as indicated in the above example, ie, the patient entering, “I cannot concentrate well”, then decision block 204 will generally proceed to process block 208, where the patient is asked a next question which builds upon the first question. In process block 210, system 20 waits for the patient to provide an answer to this question. Continuing the example above, as shown in FIG. 3 display 70 of patient 1 input/output device 44, the message “HOW LONG HAS THIS BEEN GONG FOR?” was then asked to patient 1. In turn, patient 1 responded “Since I was a child.”

Program logic then proceeds to process block 212 as shown in FIG. 2. Process block 212 sends the information the patient has entered to the health care provider input/output device 32. The information the patient has entered may be sent verbatim, or if it is voluminous, then it may compacted and edited by process block 212 before being sent to the health care provider input/output device. Similarly, process block 212 may send comments and diagnostic impressions made by system 20 to the health care provider input/output device.

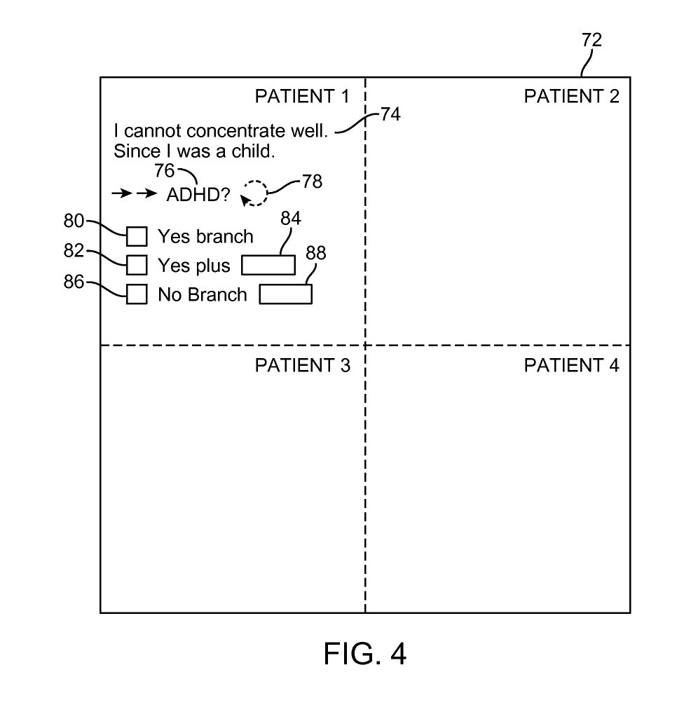

Continuing the example started above, FIG. 4 shows display 72 of health care provider 1 input/output device 32. In this example, display 72 is configured to show simultaneously information about 4 different patients. However, as is familiar to one skilled in the art of computer programming, such information could be shown in different types of overlapping windows, on separate screens, as being scrolled temporally on a common screen, and so on. As well, in this simple example being discussed here there are a single patient 1 and a single health care provider 1 participating in the example. In typical embodiments of the present invention, there will typically be a plurality of patients interacting via a plurality of patient input/output devices. As well, there can, or cannot be, a plurality of health care providers interacting via a plurality of health care provider input/output devices with a single patient or a plurality of patients.

In the area of health care provider 1 display 72 reserved for patient 1, the patient's answers 74 are shown to the health care provider. As well, the system 20 has made a hypothesis about a possible diagnosis, in the case of this example, shown as “ADHD?” 76.

In FIG. 2, in decision block 214 there is a timeout decision. Decision block 214 indicates that after a certain period of time, the program logic will not wait for an input from a health care provider but instead continue back to decision block 204. The length of this timeout period is determined by decision block 214 which in turn interacts with the rest of the executing program to determine this timeout period. If the executing program has decided that it would be better to ask another question to the patient before health care provider input would be useful, then this timeout period may only be a millisecond, i.e., in the example above the program logic would then a millisecond later (or even shorter delays are possible) transfer program control to decision block 204. The progress of a timeout may be shown graphically as shown by graphical element 78 on display 72.However, for the sake of our example if it is assumed that at this time decision block 214 logically concluded that health care provider 1 input would be useful, then the timeout period would be considerably longer. Decision block 214 would essentially be waiting, in this example, for health care provider 1 to touch the touchscreen display 72 in either locations 80, 82 or 86 to respond to choices which system 20 has given.

Continuing the example above, health care provider 1 touches location 80 indicating that he/she agrees with system 20's hypothesis of “ADHD?” 76 and agrees for system 20 to then branch off into a series of questions of about ADHD. In doing so, program logic has proceeded from decision block 214 to decision block 216 where the ‘YES’ decision for “FOLLOW RECOMMENDATIONS” has been made. This transfers program logic to decision block 220 where the ‘NO’ decision has effectively been made. (If the heath care provider had touched on location 82 then this would have indicated agreement with system 20's hypothesis but also the addition of branching to additional particular questions, and thus program logic would have proceeded to process block 218, which would have waited for the health care provider to enter information in location 84. If the health care provider had touched on location 86 then this would have directly transferred program logic to process block 218 and waited for the health care provider to enter information in location 88.)

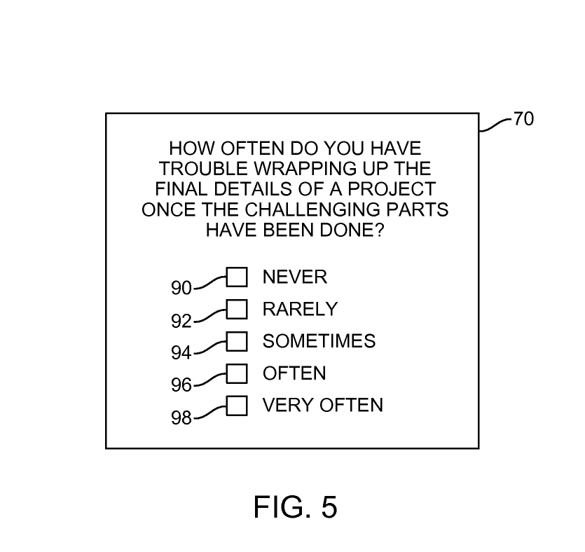

Continuing the example above, health care provider 1 has touched location 80 and in FIG. 2 program logic has returned back to decision block 204. Decision block 204 is simplified in FIG. 2 but in reality interacts with all other parts of the executing program and data stored in memory locations. The action of the health care provider 1 to accept via touching location 80 the hypothesis of “ADHD” 76 is represented by storage in particular memory locations which decision block 204 has access to. Decision block 204 accesses as well information about the hypothesis “ADHD” stored in secondary storage 28 and/or main memory 26. Depending on the information which has already been acquired from the patient, and depending on the information about the hypothesis, in this case “ADHD”, decision block 204 decides on the type and particulars of the next question or questions. Continuing the example above, as reflected in FIG. 5 in the display 70 of the patient 1 input/output device 44, it appears that program control has passed from decision block 204 to a survey question process block 206, where patient 1 is being asked, “HOW OFTEN DO YOU HAVE TROUBLE WRAPPING UP THE FINAL DETAILS OF A PROJECT ONCE THE CHALLENGING PARTS HAVE BEEN DONE?” Patient 1 is given the choice of pressing locations 90, 92, 94, 96, or 98 to provide an answer to this question, and when doing so program logic proceeds to process blocks 210, 212 and 214. If there were a number of survey questions to be completed as part of these questions on establishing a diagnosis of ADHD, then the timeout period in decision block 214 would be very short with the program logic looping around and quickly asking the next question in the survey.

FIG. 2 has been kept simple for readability, but as one skilled in the art of computer programming understands, each step of the flow diagram can involve large amounts of computer code. As well, if each of the process blocks and decision blocks are treated as objects if an object oriented programming language is used, there may be communication between these and other objects.

As noted above, input/output devices can include common touchscreens, keyboards, microphones, speakers, and so on. However, as noted above, they can also include various physical transducers such as blood pressure sensors, weight scales, and so on. Measuring such physical properties of a patient is considered to be part of the physical examination, which traditionally comes after the medical history. Thus, the present invention does not produce a pure medical history in the traditional sense of the term but may include elements of the physical examination and even laboratory examinations. Physical examination and laboratory examination data may be obtained directly by the system 20 if appropriate physical transducers are part of the patient input/output devices. For example, a blood glucose sensor physical transducer may be part of the patient input/output device. In such an embodiment of the present invention, process block 208 rather than asking the patient to answer a particular question may instead, at a certain point of the program for a particular patient, ask the patient to attach, for example, a glucose sensor to his/her earlobe, and the glucose sensor physical transducer feeds an electronic signal directly into the input/output device which goes into the patient's medical history. In another embodiment of the present invention where no such glucose sensor is available, it is possible the patient could be asked at process block 208 to type into the input/output device the values of his/her blood glucose which are on laboratory results done previously, or alternatively, this could be asked of the health care provider to do so, or where system 20 has direct access to such information via communication device 80 shown in FIG. 1, system 20 could automatically request such information.

At some point the medical history generation will terminate within decision block 222 and program control will go back to the start of the program to process block 202, ready for the next patient. The information which system 20 has received from the patient has been during the process, or is at this point, stored in main memory 26 and/or secondary storage 28, and/or sent to another system via communication device 80 and/or is stored in the storage associated with optional computers 42, 46, 50, 30, 34, 38. If in the example above health care provider 1 is now to see patient 1 to complete the examination, diagnosis and treatment in person, health care provider 1 can access the automatically generated medical history which has been stored in main memory 26 and/or secondary storage 28, and/or in another computer system via communication device 80 and/or is stored in the storage associated with optional computers 42, 46, 50, 30, 34, 38.

In the example above health care provider 1 interacted with patient 1, i.e., a single health care provider participated in the automated generation of a single patient's medical history. However, the cost effectiveness of system 20 is that a single health care provider can participate in the simultaneous automatic generation of a plurality of medical records. For example, in FIG. 4 the display 72 used by health care provider 1 is configured in this embodiment for simultaneous viewing of four patients.

System 20 can also allow a plurality of health care providers to participate in the simultaneous automatic generation of a plurality of medical histories. This can be useful in clinic environments where there are large numbers of patients to be served.

Although the above description of a preferred embodiment contains many specificities, these should not be taken as limitations on the scope of the present invention but simply as a description of a preferred embodiment. Many other embodiments of the present invention are possible. The present invention is not limited to any particular type of computer apparatus or programming environment.

As well, the present invention is not limited to the specific applications described above. The system and method of the present invention have many other applications in various health fields as well as outside of the health fields. For example, an alternative embodiment of the present invention could be an embodiment to be used by a corporate human resource department to obtain employment history and background history from job application candidates. In this case the ‘patient’ would more generically be the ‘user’ and the ‘health care provider’ would be more generally the ‘system operator’.

Thus, the scope of the present invention should not be constrained by the examples given, but by the claims and their legal equivalents.

What is claimed is:

1. A computer-implemented method comprising:
generating questions for a user to answer and receiving from the user answers to these questions;
receiving from a systems operator information which alters the questions which are generated or in the case of lack of such information allowing the questions to proceed unaltered;
storing in a computer-accessible storage medium a plurality of questions which can be asked to different users;
storing in a computer-accessible storage medium answers received from the user; and
the systems operator receiving from a computer-accessible storage medium the stored history which the user provided to the computer.

2. The method of claim 1, further comprising:
a greater quantity of users than quantity of system operators; and
the ability of a system operator to participate in the automatic generation of histories from a plurality of simultaneous patients.

3. The method of claim 1, further comprising:
a user interface that contains a physical transducer that can take a measurement of a physical property of the user.

4. The method of claim 1, further comprising:
where the user is a patient seeking health care, and the system operator is a health care provider.

5. The method of claim 1, further comprising:
a plurality of tablet computers each containing a touchscreen, speaker, microphone and camera where said tablet computers are used as the user interface for both the users of the system as well as the system operator.

6. The method of claim 1, further comprising:
the computer system suggesting to the system operator a possible assessment hypothesis concerning the user who is answering questions at the system.

7. The method of claim 1, further comprising:
the computer system suggesting to the health care provider a possible diagnostic hypothesis concerning the patient answering questions at the system.

8. The method of claim 1, further comprising:
a variable timeout function whereby if the system operator does not respond within the variable timeframe allowed by said timeout function, the computer system continues asking the user questions without the system operator's input.

9. A computer system comprising:
a plurality of user interfaces configured for receiving from users answers to questions generated by the computer system;
an interface configured for transmitting from a system operator to the computer system information which will cause modification of the questions generated by said computer system;
at least one central processing unit, one main memory unit and one secondary storage unit;
at least one device allowing communication with other computer systems; a user interface configured for retrieving from the main memory unit and/or secondary storage unit to the system operator the stored record of the answers provided by a user to questions generated by the computer system; and
a variable timeout function whereby if the system operator does not respond within the variable timeframe allowed by said timeout function, the computer system continues to ask the user questions without the system operator's input.

10. The method of claim 9, further comprising:
a user interface that contains a physical transducer that can take a measurement of a physical property of the user.

11. The method of claim 9, further comprising:
where the user is a patient seeking health care, and the system operator is a health care provider.

12. The method of claim 9, further comprising:
a plurality of tablet computers each containing a touchscreen, speaker, microphone and camera where said tablet computers are used as the user interface for both the users of the system as well as the system operator.

13. The method of claim 9, further comprising:
the computer system suggesting to the system operator a possible assessment hypothesis concerning the user who is answering questions at the system.

14. The method of claim 9, further comprising:
the computer system suggesting to the health care provider a possible diagnostic hypothesis concerning the patient answering questions at the system.

15. The method of claim 9, further comprising:
the main memory unit being integrated with the central processing unit.
